(19) United States
(12) Patent Application Publication
(10) Pub. No.: US 2007/0229909 A1
(43) Pub. Date: Oct. 4, 2007

(54) INFORMATION PROCESSING APPARATUS, INFORMATION PROCESSING SYSTEM, CONTROL METHOD, PROGRAM, AND STORAGE MEDIUM

(75) Inventors: Hironobu Kitabatake, Ohta-ku (JP); Shuji Someya, Adachi-ku (JP); Hidetoshi Asasaka, Sagamihara-shi (JP); Takeshi Ooyama, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/685,937

(22) Filed: Mar. 14, 2007

(30) Foreign Application Priority Data
Apr. 3, 2006 (JP) 2006-102088

(51) Int. Cl. H04N 1/00

(52) U.S. Cl. 358/404

(57) ABSTRACT

An apparatus stores first document information including a plurality of feature information, which are extracted from an image of a first document and respectively extracted based on a plurality of different orientations, and second document information including feature information extracted from an image of a second document from at least one orientation. The apparatus determines that the first document and the second document are the same if any one of the feature information included in the first document information matches the feature information included in the second document information, and determines that the first document and the second document are not the same if none of the plurality of feature information included in the first document information matches the feature information included in the second document information.

### BACKGROUND OF THE INVENTION

1. Field of the Invention

The present invention relates to an information processing apparatus, an information processing system, a control method therefor, a program, and a storage medium for processing information using feature information extracted from an image of an original document.

2. Description of the Related Art

Conventionally, various methods have been proposed for processing information using feature information extracted from an image of an original document.

For example, Japanese Patent Application Laid-Open No. 2004-320378 discusses a method for assuring an authenticity of an original document. The method disclosed in Japanese Patent Application Laid-Open No. 2004-320378 includes extracting feature information from data obtained by digitizing an image of an original document, registering the extracted feature information in a terminal apparatus on a network, and then comparing feature information extracted at the time of verifying an authenticity of an original document with a previously-registered feature information to assure an authenticity of the original document.

In addition, Japanese Patent Application Laid-Open No. 2004-252660 discusses a method for producing a certification by reading a printed document and collating the read printed document with an electronic document acquired from a server to determine whether the printed document has been altered or not. Thus, an authenticity of a printed document can be certified at a remote place.

However, such a conventional method does not consider an orientation of an original document that is read in previously registering authentic original document information and in verifying an authenticity of a printed product.

For example, in registering a printed product as an authentic original document, feature information of the printed product is extracted by reading the printed product with a scanner apparatus, and thus the extracted feature information can be registered. Subsequently, in order for a user to verify whether a printed product is the same as the registered authentic original document, the printed product is read again to extract its feature information.

However, in the above-described conventional method, if an orientation of a printed product set on a scanner apparatus is different from an orientation of a registered authentic original document (for example, if the orientation of the printed product is rotated by 180°), feature information different from the feature information of the registered authentic original document is extracted. Thus, in this case, it is determined that the printed product is different from the registered authentic original document even if the printed product is the same as the registered authentic original document in actuality.

More specifically, in the method disclosed in Japanese Patent Application Laid-Open No. 2004-320378, when an orientation of an original document read at the time of registering the original document with an authenticity assurance server on a network differs from an orientation of an original document read at the time of verifying an authenticity, it is determined that the original documents are not the same. In this case, the original document read as a verifying object is not certified as an authentic original document.

Furthermore, in the method discussed in Japanese Patent Application Laid-Open No. 2004-252660, when a printed document is not properly oriented at the time of reading the printed document, an appropriate result of collation with an electronic document acquired from a server may not be obtained. In this case, an authenticity of the document may not be assured.

### SUMMARY OF THE INVENTION

Embodiments of the present invention are directed to a method for enabling an appropriate determination as to whether first document and second document are the same by extracting feature information of the first document based on each of a plurality of different orientations in extracting feature information from the first document, even when an orientation of the first document is different from an orientation of the second document obtained at the time of extraction of feature information thereof.

According to an aspect of the present invention, an embodiment is directed to an apparatus including: an extraction unit configured to, based on an image of a document, extract feature information of the image; a storage unit configured to store first document information including a plurality of feature information, which are extracted by the extraction unit from an image of a first document and respectively extracted based on a plurality of different orientations, and second document information including feature information, which is extracted by the extraction unit from an image of a second document and extracted based on at least one orientation; a comparison unit configured to compare the feature information included in the second document information with the plurality of feature information included in the first document information; a determination unit configured to determine, as a result of a comparison by the comparison unit, if either one of the plurality of feature information included in the first document information matches the feature information included in the second document information, that the first document and the second document are the same, and if none of the plurality of feature information included in the first document information matches the feature information included in the second document information, that the first document and the second document are not the same; and an output unit configured to output information indicating a result of a determination by the determination unit.

According to another aspect of the present invention, an embodiment is directed to a method including: storing first document information including a plurality of feature information, which are extracted from an image of a first document and respectively extracted based on a plurality of different orientations; storing second document information including feature information, which is extracted from an image of a second document and extracted based on at least one orientation; comparing the feature information included in the second document information with the plurality of feature information included in the first document information; and determining, as a result of the comparison, if either one of the plurality of feature information included in the first document information matches the feature information included in the second document information, that the first document and the second document are the same.

Further features and aspects of the present invention will become apparent from the following detailed description of exemplary embodiments with reference to the attached drawings.

### BRIEF DESCRIPTION OF THE DRAWINGS

The accompanying drawings, which are incorporates in and constitute a part of the specification, illustrate exemplary embodiments, features, and aspects of the invention and, together with the description, serve to explain the principle of the invention.

FIG. 1 illustrates an exemplary configuration of a multifunction peripheral (MFP) according to a first exemplary embodiment of the present invention.

FIG. 2 illustrates an exemplary external appearance of an operation unit according to the first exemplary embodiment of the present invention.

FIG. 3 illustrates an exemplary external appearance of an MFP according to the first exemplary embodiment of the present invention.

FIG. 4 illustrates an exemplary configuration of a system according to the first exemplary embodiment of the present invention.

FIG. 5 schematically illustrates an exemplary configuration of an authenticity assurance server according to the first exemplary embodiment of the present invention.

FIG. 6 illustrates a user authentication screen displayed on an operation screen according to the first exemplary embodiment of the present invention.

FIG. 7 illustrates a copy initial screen displayed on an operation screen according to the first exemplary embodiment of the present invention.

FIG. 8 illustrates a send/fax initial screen displayed on an operation screen according to the first exemplary embodiment of the present invention.

FIG. 9 illustrates a reading setting screen displayed on an operation screen according to the first exemplary embodiment of the present invention.

FIG. 10 illustrates an authentic original document information registration setting screen displayed on an operation screen according to the first exemplary embodiment of the present invention.

FIG. 11 illustrates a registration information display screen displayed on an operation screen according to the first exemplary embodiment of the present invention.

FIG. 12 illustrates an authentic original document information examination setting screen displayed on an operation screen according to the first exemplary embodiment of the present invention.

FIG. 13 illustrates an examination detail display screen displayed on an operation screen according to the first exemplary embodiment of the present invention.

FIG. 14 is a flow chart illustrating a flow of processing according to the first exemplary embodiment of the present invention.

FIG. 15 illustrates, in detail, processing for extracting feature information according to the first exemplary embodiment of the present invention.

FIG. 16 illustrates, in detail, the processing for extracting feature information according to the first exemplary embodiment of the present invention.

FIG. 17 illustrates a feature information management table according to the first exemplary embodiment of the present invention.

FIG. 18 is a flow chart illustrating a flow of processing according to the first exemplary embodiment of the present invention.

FIG. 19 is a flow chart illustrating a flow of processing according to the first exemplary embodiment of the present invention.

FIG. 20 is a flow chart illustrating a flow of processing according to a second exemplary embodiment of the present invention.

FIG. 21 is a flow chart illustrating a flow of processing according to the second exemplary embodiment of the present invention.

FIG. 22 is a flow chart illustrating a flow of processing according to the second exemplary embodiment of the present invention.

FIG. 23 is a flow chart illustrating a flow of processing according to a third exemplary embodiment of the present invention.

### DETAILED DESCRIPTION OF THE EMBODIMENTS

Various exemplary embodiments, features and aspects of the present invention will now herein be described in detail with reference to the drawings. It is be noted that the relative arrangement of the components, the numerical expressions, and numerical values set forth in these embodiments are not intended to limit the scope of the present invention unless it is specifically stated otherwise.

### First Exemplary Embodiment

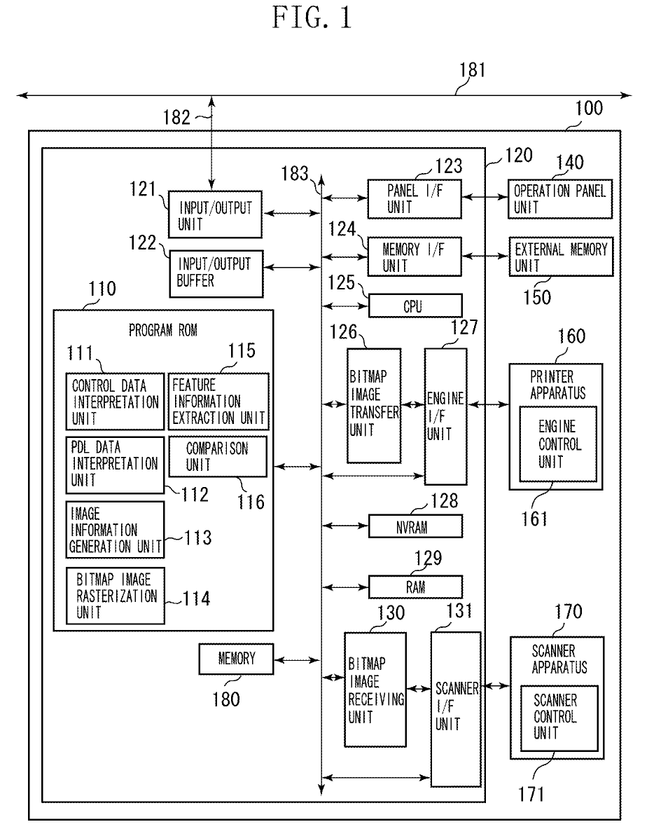

FIG. 1 illustrates an exemplary system configuration of a multifunction peripheral (MFP) constituting a part of an authenticity assurance system according to a first exemplary embodiment of the present invention. Referring to FIG. 1, an MFP 100 is capable of reading and inputting an image of an original document, printing and storing the image, and sending image data to another external apparatus.

The MFP 100, in a large sense, includes a control unit 120 that controls the entire MFP 100, a printer apparatus 160 that prints an output image on a recording sheet of paper, and a scanner apparatus 170 that reads an image of an original document and inputs the read image in the MFP 100 as image data.

The control unit 120 is connected with external apparatuses, such as client terminal apparatuses and server terminal apparatuses, via a network cable 182 connected to a network 181. The control unit 120 communicates with each terminal apparatus via an input/output unit 121, which controls input and output of data from and to an external apparatus.

An input/output buffer 122 is used to send and receive control code for printing, various page description language (PDL) data, and various data concerning the MFP 100 and external apparatuses via a network.

A central processing unit (CPU) 125 controls an operation of the control unit 120. A program read-only memory (ROM) 110 stores a program including a description concerning an operation of the CPU 125. The CPU 125 reads and executes a program stored in the program ROM 110 to implement each function of the MFP 100.

A random access memory (RAM) 129 is utilized as a work memory used for interpreting and printing control code and data, computation necessary for reading an image, and processing of image data that is input and output. A non-volatile random access memory (NVRAM) 128 stores data that needs to be stored even when the MFP 100 is powered off.

A control data interpretation unit 111 and a PDL data interpretation unit 112, which are included in the program ROM 110, respectively interpret print control data and PDL data received from an external personal computer (PC). An image information generation unit 113 generates various types of image objects. A bitmap image rasterization unit 114 rasterizes an image object into a bitmap image.

A feature information extraction unit 115 extracts feature information (for example, a hash value) from a bitmap image acquired from the bitmap image rasterization unit 114. The feature information extracted by the feature information extraction unit 115 is sent to an external apparatus via the network 181 or to a memory 180.

A bitmap image transfer unit 126 transfers to the printer apparatus 160 a bitmap image rasterized by the bitmap image rasterization unit 114 and a bitmap image acquired from the scanner apparatus 170 by reading an original document.

An engine interface (I/F) unit 127 is an interface that connects the bitmap image transfer unit 126 with an engine control unit 161 of the printer apparatus 160.

A bitmap image receiving unit 130 receives a bitmap image read by the scanner apparatus 170. A scanner I/F unit 131 is an interface that connects a scanner control unit 171 of the scanner apparatus 170 with the bitmap image receiving unit 130.

A comparison unit 116 compares feature information extracted by the feature information extraction unit 115 from a bitmap image received by the bitmap image receiving unit 130 with feature information stored in the memory 180. In an embodiment, in the case where comparison processing is performed by an authenticity assurance server to be described later below, the comparison unit 116 is not required.

The CPU 125 determines whether documents from which the respective feature information are extracted are the same based on a result of the comparison by the comparison unit 116. The comparison and determination processing is to be described later below.

An operation panel unit 140 can receive an instruction for operating the MFP 100 from a user or display an error message, a result of processing, and an operation guide. A panel I/F unit 123 is an interface that connects the operation panel unit 140 with the control unit 120.

An external memory unit 150 can store print data, image data that is externally input, and various information about the MFP 100. The external memory unit 150 is connected with the control unit 120 via a memory I/F unit 124. A system bus 183 mutually connects the units described above.

The engine control unit 161, which is included in the printer apparatus 160, controls printing ranging from feeding of paper to printing and discharging. The scanner control unit 171, which is included in the scanner apparatus 170, controls a scan operation ranging from feeding of an original document for reading an image to discharging of the original document.

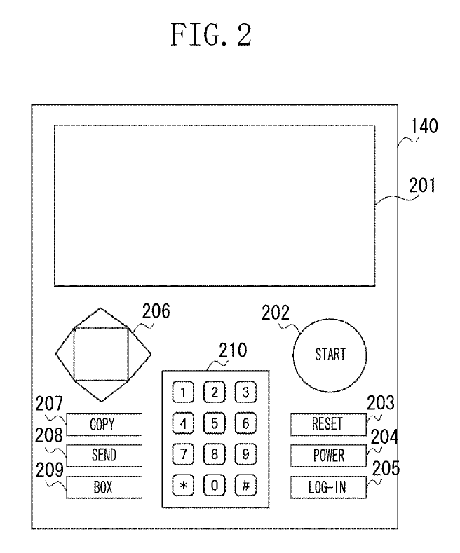

FIG. 2 schematically illustrates an exemplary external configuration of the operation panel unit 140. Referring to FIG. 2, a liquid crystal panel unit 201 displays a preview of a registered image, apparatus information such as a print status, or a result of various processings. Furthermore, the liquid crystal panel unit 201 is a touch panel that detects positional information about a portion touched by a user. The user can generate an instruction for various processings and enter text information via the liquid crystal panel unit 201.

A start button 202 can be pressed by the user to instruct a start of a copy function and a sending function.

In addition, the operation panel unit 140 includes hard keys including a reset button 203, a power button 204, a numeric keypad 210, and a cursor key 206. The reset button 203 is used to reset the MFP 100. The power button 204 is used to power on and off the MFP 100. The numeric keypad 210 is used to enter the number of copies to make. The cursor key 206 is used to operate a cursor displayed on the liquid crystal panel unit 201. Moreover, the operation panel unit 140 includes mode keys for switching between function modes of the MFP 100, such as a copy key 207, a send key 208, and a box key 209.

A log-in key 205 can be pressed by the user when the user performs an operation to be certified as an authenticated user before operating the MFP 100. When the user presses the log-in key 205 in a state where the user has already logged into the MFP 100, the user can log out of the MFP 100. An operation performed for user authentication is to be described in detail later below.

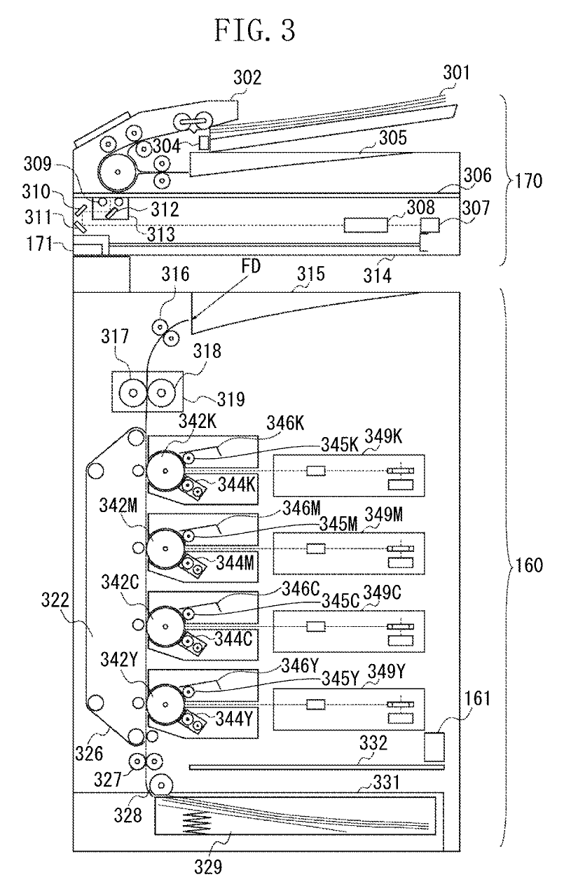

FIG. 3 illustrates an exemplary configuration of the MFP 100. Referring to FIG. 3, the MFP 100 includes, in a large sense, a housing 315 of the printer apparatus 160, a document feed unit 302 that feeds a document to the scanner apparatus 170, and a scanner unit 314 that reads an original document.

The housing 315 contains various mechanisms that configure the printer apparatus 160, the engine control unit 161 that performs a control related to each print processing performed by each mechanism, and a control board storage unit 332 that stores the control unit 120 illustrated in FIG. 1.

The MFP 100 is capable of performing full-color printing using toners of four colors, namely, cyan (C), magenta (M), yellow (Y), and black (K). Thus, the MFP 100 includes four photosensitive drums 342 (a photosensitive drum 342C, a photosensitive drum 342M, a photosensitive drum 342Y, and a photosensitive drum 342K), which are image bearing members installed vertically in tandem in the direction of conveyance.

Each of charging apparatuses 345 (a charging apparatus 345C, a charging apparatus 345M, a charging apparatus 345Y, and a charging apparatus 345K) uniformly charges a surface of the photosensitive drum 342. Each of print scanner units 349 (a print scanner unit 349C, a print scanner unit 349M, a print scanner unit 349Y, and a print scanner unit 349K) scans and irradiates a laser beam based on image information and forms an electrostatic latent image on the photosensitive drum 342.

Each of development apparatuses 344 (a development apparatus 344C, a development apparatus 344M, a development apparatus 344Y, and a development apparatus 344K) allows toner to adhere to an electrostatic latent image to develop the electrostatic latent image as a toner image.

An electrostatic conveyance and transfer apparatus 322 transfers a toner image on the photosensitive drum 342 onto a transfer material. Each of cleaning apparatuses 346 (a cleaning apparatus 346C, a cleaning apparatus 346M, a cleaning apparatus 346Y, and a cleaning apparatus 346K) removes toner remaining on a surface of the photosensitive drum 342 after a toner image is transferred thereon.

An electrostatic conveyance belt 326 is a belt member opposing each of the photosensitive drums 342 and moves in circulation to abut onto each of the photosensitive drums 342. The electrostatic conveyance belt 326 is vertically supported by four rollers. Furthermore, the electrostatic conveyance belt 326 electrostatically attracts a transfer material onto an outer peripheral surface thereof, which is illustrated as a left-hand side in FIG. 3, and moves in circulation so as to allow the transfer material to contact the photosensitive drum 342. Thus, the transfer material is conveyed by the electrostatic conveyance belt 326 up to a transfer position, where a toner image on each photosensitive drum 342 is serially transferred onto the transfer material.

A paper feed unit 331 feeds a transfer material to an image forming unit. A plurality of transfer materials are stacked in a paper feed cassette 329 of the paper feed unit 331. At the time of forming an image, a paper feed roller 328 and a registration roller pair 327 are driven to be rotated according to an image forming operation so as to separately feed the transfer materials stored in the paper feed cassette 329 sheet by sheet. Then, a leading edge of the transfer material abuts onto the registration roller pair 327 and temporarily stops there. Then, the transfer material forms a loop to be fed to the electrostatic conveyance belt 326.

A fixing unit 319 fixes a plurality of toner images transferred onto a transfer material. The fixing unit 319 includes a heat roller 318, which is driven to be rotated, and a pressure roller 317 that contacts the heat roller 318 to apply heat and pressure to the transfer material.

That is, the transfer material onto which toner images on the photosensitive drums 342 have been transferred is conveyed by the pressure roller 317 and the heat roller 318 at the time of passing through the fixing unit 319 while being applied with heat and pressure by the pressure roller 317. Thus, toner images of a plurality of colors are fixed onto a surface of the transfer material. Subsequently, the fixed transfer material is discharged to a discharge unit by a discharge roller pair 316.

In addition, the MFP 100 is capable of reading and inputting an image of an original document using the scanner apparatus 170. A document feed unit (DF unit) 302 of the scanner apparatus 170 feeds original documents 301 onto a platen glass 306 sheet by sheet from top to bottom. Furthermore, after the reading of the original document by the scanner unit 314 is completed, the DF unit 302 discharges the document on the platen glass 306 onto a discharge tray 305.

A sensor 304 detects the presence or absence of an original document. When an original document is conveyed onto the platen glass 306, the scanner unit 314 turns on a lamp 309, and then starts moving an optical unit 313 to exposure and scan the document.

At this time, reflected light from the original document is guided to a charge-coupled device (CCD) image sensor (hereinafter simply referred to as a “CCD”) 307 via mirrors 312, 310, and 311 and a lens 308. An image of the original document scanned in this manner is read by the CCD 307.

Image data output from the CCD 307 is subjected to given processing, and then transferred to the control unit 120 via the scanner I/F unit 131.

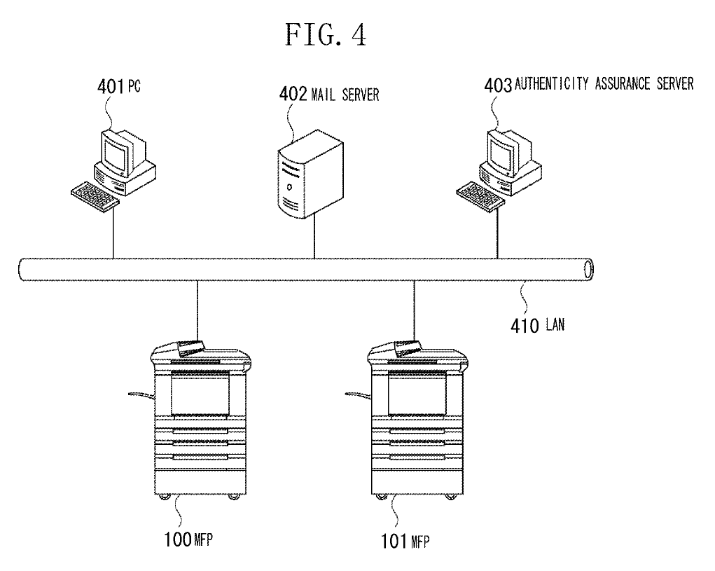

FIG. 4 illustrates an exemplary configuration of the authenticity assurance system according to the first exemplary embodiment. Referring to FIG. 4, the MFP 100 and an MFP 101 having a similar function as the MFP 100 are utilized as a terminal apparatus for inputting and outputting various data.

In addition, the MFP 100 and the MFP 101 are connected to a local area network (LAN) 410. Thus, each of the MFP 100 and the MFP 101 is capable of performing various communications with each client terminal apparatus and each server terminal apparatus connected to the LAN 410 such as PC 401 and Mail Server 402 to send and receive data. Note that, in this system, the terminal apparatuses can be connected via various communication media such as the Internet instead of the LAN 410.

An authenticity assurance server 403 is connected to the LAN 410 and can receive a request for performing a service related to assurance of authenticity from the MFP 100 or the MFP 101. More specifically, the authenticity assurance server 403, in order to register information specified as an authentic original document via the MFP 100 or the MFP 101, receives and registers information (including image data or feature information) based on the document to be registered.

In addition, the authenticity assurance server 403 receives, from the MFP 100 or the MFP 101, a request for comparing an original document with an authentic original document (verify an authenticity of an original document) and determines whether the original document is the same as the authentic original document by comparing received information with information stored in the authenticity assurance server 403.

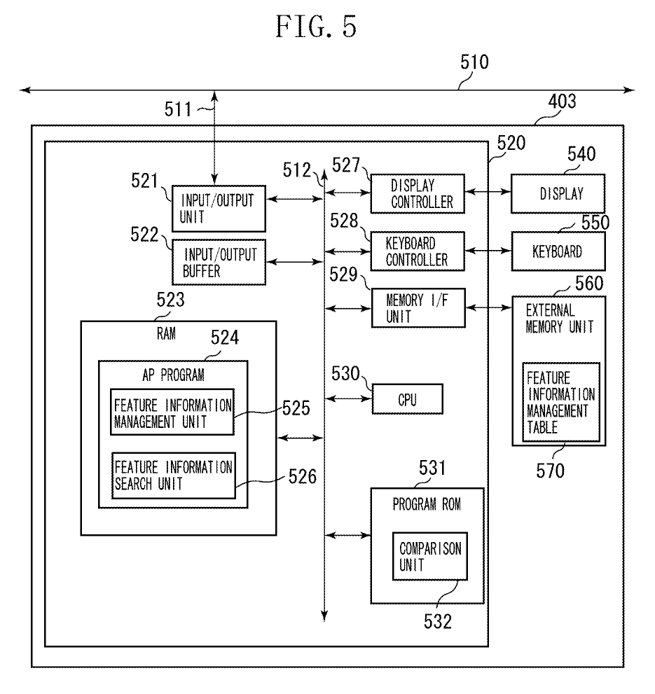

FIG. 5 illustrates an exemplary system configuration of the authenticity assurance server 403 according to the first exemplary embodiment.

Referring to FIG. 5, a control unit 520 includes a CPU 530 that controls an operation of the authenticity assurance server 403 and a program ROM 531 that includes therein a program including a description as to an operation of the CPU 530.

The CPU 530 reads and executes a program stored in the program ROM 531 to implement each function of the authenticity assurance server 403.

In addition, the control unit 520 performs a communication with each terminal apparatus via an input/output unit 521, which controls input and output of data from and to another terminal apparatus on a network 510 via a network cable 511. Moreover, the program ROM 531 includes a comparison unit 532, which has a function similar to that of the comparison unit 116 of the MFP 100.

An input/output buffer 522 is used to send and receive various control codes, feature information, and various data via a network.

A RAM 523 is utilized as a work memory used for performing a computation necessary for interpreting and printing control code and data and processing for processing print data. An application (AP) program 524 included in the RAM 523 describes an operation of application software and a driver operating on a computer.

A feature information management unit 525 receives and manages feature information extracted from a document that is used as an authentic original document at the time of registration of authentic original document information using the AP program 524. In addition, a feature information search unit 526 searches for feature information of an authentic original document that is requested based on a search condition received at the time of examination of authentic original document information.

A display 540 displays an image processed by a computer. A display controller 527 controls the display 540. A keyboard 550 receives an input by the user. A keyboard controller 528 controls the keyboard 550.

An external memory unit 560 is a non-volatile memory, such as a hard disk, utilized for storing print data and various information about a host computer. The external memory unit 560 is connected to the control unit 520 via a memory I/F unit 529.

The external memory unit 560 includes a feature information management table 570. The feature information management table 570 manages feature information stored (registered) in the authenticity assurance server 403. The functional units described above are mutually connected via a system bus 512.

Now, processing for assuring authenticity performed by the system having the above-described configuration is specifically described in the following. Here, authentic original document information refers to information about an original document specified as an authentic original document. Registered information refers to information about an original document registered as an authentic original document. Verification information refers to information about an original document to be verified for its authenticity.

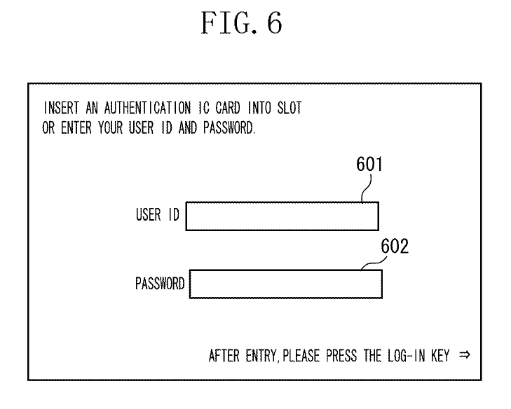

FIG. 6 illustrates an example of a screen displayed on the liquid crystal panel unit 201 of the operation panel unit 140 illustrated in FIG. 2. The screen illustrated in FIG. 6 is displayed to be used by the user, before operating the MFP 100, to enter a user identification (ID) and a password to be certified as an authenticated user and to log into the MFP 100.

When a user enters a user ID in a user ID entry field 601 and a password in a password entry field 602 and presses the log-in key 205 illustrated in FIG. 2, the MFP 100 collates the entered user ID and password with user information previously registered with the memory 180. If it is confirmed that the entered user ID and password match the registered user information, the user is allowed to login to the MFP 100. At this time, the stored authentication information can be read by allowing the user to insert an integrated circuit (IC) card, instead of requiring the user to enter a user ID and a password.

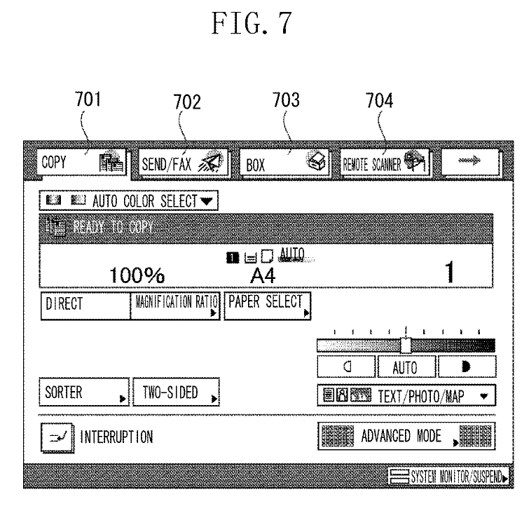

FIG. 7 is a copy initial screen that is displayed first after the user has logged into the MFP 100. Referring to FIG. 7, mode keys 701 through 704 can be pressed by the user to switch between functional modes of the MFP 100.

In performing copy processing in which data is input by the scanner apparatus 170 and output by the printer apparatus 160, the user can perform a detailed setting via the copy initial screen and press the start button 202 to start the copy processing.

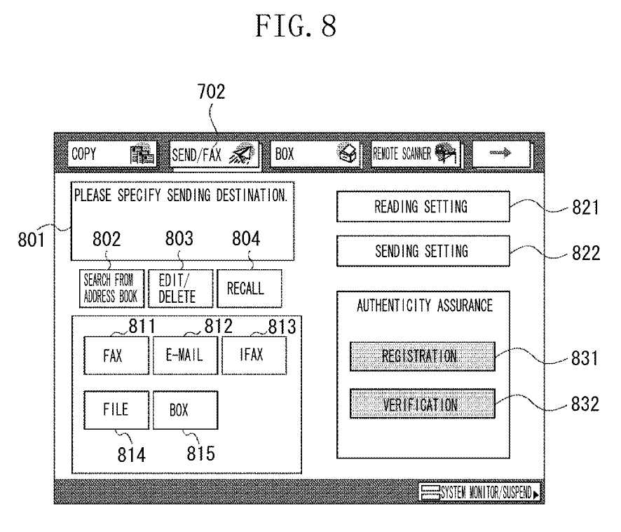

FIG. 8 illustrates a send/fax initial screen that is displayed when the mode key 702 is pressed by the user.

The user can perform various detailed settings via the send/fax initial screen to send data input by the scanner apparatus 170 to an external apparatus, to store the data input by the scanner apparatus 170 into a storage area in the MFP 100, or to send and receive facsimile data.

Referring to FIG. 8, in a sending destination display field 801, a sending destination set using an address book, which is to be described later below, can be displayed. A “search from address book” button 802 can be pressed by the user to read information about a sending destination that is previously registered and to set the information as a sending destination to be used for the current operation.

An “edit/delete” button 803 can be pressed by the user to edit or delete a sending destination that is already set or to directly enter a new sending destination. A “recall” button 804 can be pressed by the user to read destination information that has been used before.

Sending method selection buttons 811 through 815 can be pressed by the user to display a screen used for performing a detailed setting according to a sending method such as facsimile or e-mail. For example, in sending an e-mail using an Internet facsimile (IFAX), in which an e-mail including an image having a facsimile form is sent, an e-mail address of a sending destination, a resolution, and a compression type can be set using the sending method selection button 813.

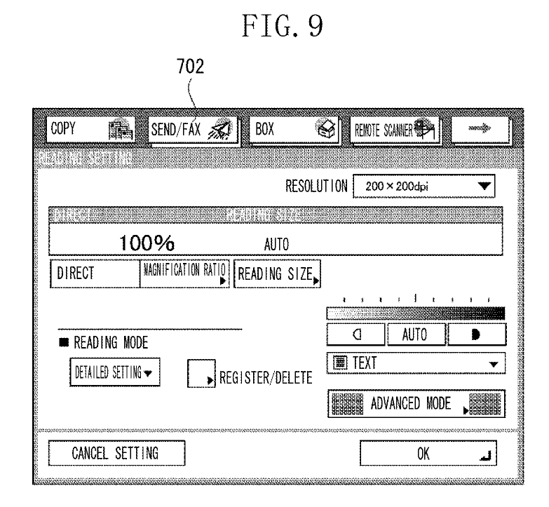

A reading setting button 821 can be used by the user to perform a detailed setting in reading and inputting an image of an original document using the scanner apparatus 170. When the user presses the reading setting button 821, a reading setting screen illustrated in FIG. 9 is displayed. The user can set an original paper size and a resolution used for reading via the reading setting screen.

A sending setting button 822 can be pressed by the user to perform a detailed setting in sending encrypted data and in sending data with a password attached thereto.

A registration button 831 and an verification button 832 can be pressed by the user to utilize an authenticity assurance service.

Here, “registration” refers to an operation in which, for example, a document is read and input by the scanner apparatus 170 and, then, document information based on the input document is registered as an authentic original document with an authenticity assurance server on a network. In addition, “verification” refers to an operation in which, for example, a document owned by the user is read and input by the scanner apparatus 170, document information based on the input document is used as verification information, and the verification information is compared with registration information that is previously registered as information about an authentic original document so as to determine whether the verification information and the registration information match each other and whether the input document has been altered (falsified).

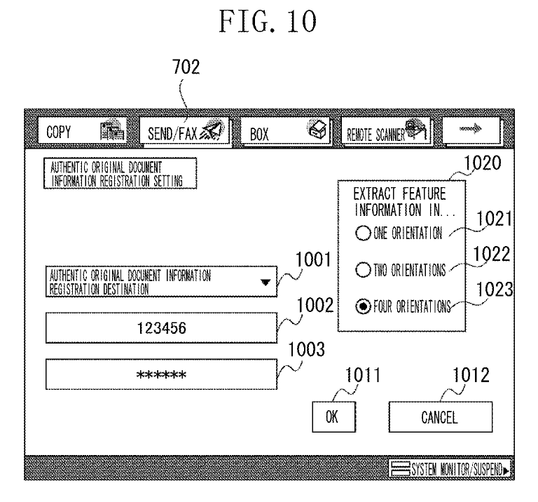

FIG. 10 illustrates an authentic original document information registration setting screen, which is displayed when a user presses the registration button 831.

Referring to FIG. 10, the user can select an authenticity assurance server from among authenticity assurance servers on a network, which are displayed in a drop-down list, via a registration destination selection field 1001. At this time, if the desired authenticity assurance server is not included in the drop-down list, the user can directly enter information for identifying the desired authenticity assurance server, such as an Internet Protocol (IP) address.

The user can enter a user ID for utilizing the authenticity assurance service via an ID entry field 1002. In a password entry field 1003, the user can enter a password corresponding to the user ID entered into the ID entry field 1002.

At this time, the user authentication performed via the screen illustrated in FIG. 6 and the user authentication performed during the authenticity assurance service can be performed in cooperation with each other, so that the user is not required to separately enter a user ID and a password via the screen illustrated in FIG. 10. With this configuration, an operation required for the user can be simplified.

Here, the user authentication performed using a user ID and a password has an effect such that a contract user, to whom the authenticity assurance service can be provided, can be authenticated, or that authentic original document information can be registered together with user information.

Via a feature information extraction method selection field 1020, the user can select either one of radio buttons 1021 through 1023 to specify a method for extracting feature information. That is, when the radio button 1021 is selected by the user, just as in the case of a conventional method, feature information of an image of an original document is extracted based on a default orientation that is previously set.

Furthermore, when the radio button 1022 is selected by the user, feature information is further extracted based on an orientation in which the original document is rotated by 180°, as well the feature information extracted based on the default orientation. Moreover, when the radio button 1023 is selected, as well as the feature information extracted based on the default orientation, feature information is further extracted based on each of orientations in which the original document is rotated by 90°, 180°, and 270°, respectively.

When the entry by the user via the authentic original document information registration setting screen is completed, the user can press an OK button 1011 or the start button 202 to start reading an original document that is to be registered as an authentic original document. In addition, when the user presses a cancel button 1012, all the entered contents are discarded, and the display returns to the send/fax initial screen illustrated in FIG. 8.

When the reading of the original document is completed, the feature information extracted from the read data is registered with an authenticity assurance server. At this time, when the radio button 1022 or the radio button 1023 is selected by the user, a plurality of feature information are extracted. In this case, the extracted plural feature information are associated with one another to be registered with the authenticity assurance server.

Note that image data itself, as well as the feature information, can be associated with the authentic original document in registering the authentic original document with the authenticity assurance server. Thus, the user is not required to use a registration ID, which is to be described later below, to identify registration data and can perform a collation related to an authenticity assurance after the registration data is identified with an image search, for example. Accordingly, the user's convenience can be improved.

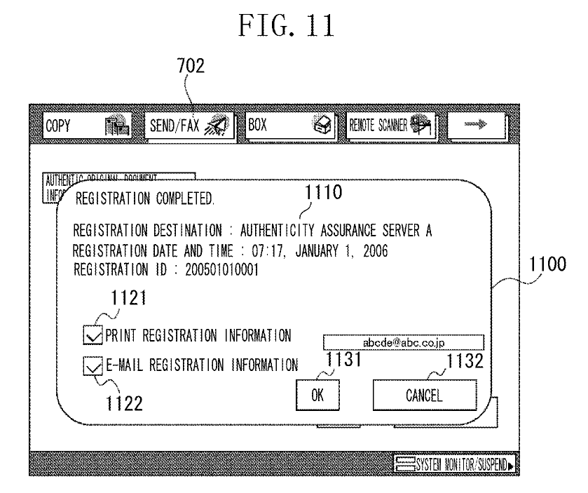

FIG. 11 illustrates a registration completion screen displayed when a registration with an authenticity assurance server is completed.

The registration completion screen 1100 includes a registration data display field 1110. In the registration data display field 1110, an apparatus name of a registration destination, a date and time of registration, and a registration ID are displayed as registration data. These kinds of information are used for identifying registered authentic original document information in performing an examination for authenticity.

In printing out the registration data described above, the user can check a check box 1121 and press an OK button 1131 to print out the content of the registration data using the printer apparatus 160.

In addition, in sending the registration data by e-mail, the user can check a check box 1122, enter an e-mail address of a sending destination, and then press the OK button 1131. With this operation, the registration data is sent by e-mail to the specified sending destination. By printing the registration data or outputting the registration data by sending via e-mail, the user is not required to take a note of the registration data by hand.

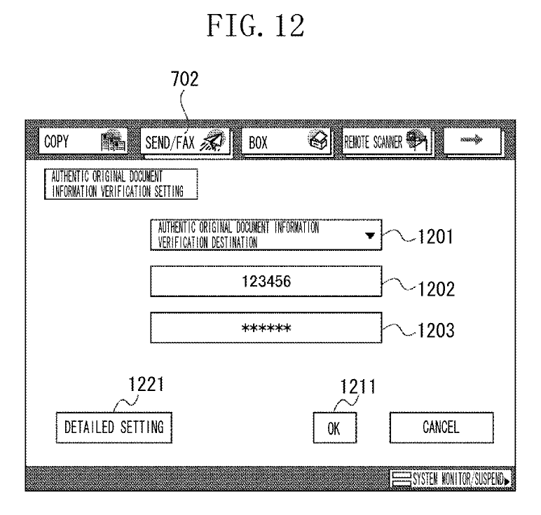

Now, processing for “verification” is described in detail below. FIG. 12 illustrates an authentic original document information verification setting screen displayed when the user presses the verification button 832.

Referring to FIG. 12, a user selects an authenticity assurance server on a network from among authenticity assurance servers displayed in a drop-down list, via an verification destination selection field 1201. At this time, if the desired authenticity assurance server is not included in the drop-down list, the user can directly enter information for identifying the desired authenticity assurance server, such as an Internet Protocol (IP) address.

Via an ID entry field 1202 and a password entry field 1203, the user can enter authentication information for utilizing an authenticity assurance service, just as in the case of entering a user ID and a password via the authentic original document information registration setting screen. Here, the user can search for desired registration data from a plurality of authenticity assurance servers on a network based on search conditions described later below, instead of selecting an authentic original document information examination destination.

Thus, data can be verified for authenticity even when the user does not remember the authenticity assurance server to which the registration data is registered. Furthermore, comparison with a plurality of registration data can be performed by a single operation without specifying an original document to be verified.

In performing a more detailed setting as to the verification, the user can press a detailed setting button 1221.

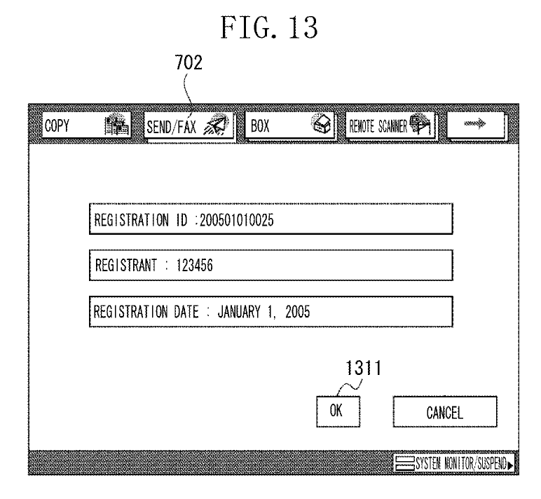

FIG. 13 illustrates a screen displayed when the user presses the detailed setting button 1221. Here, when the registration ID, which is information identifying registration information about an original document to be verified, is available, the user enters the registration ID.

On the other hand, if the registration ID is not available to the user, the user can specify a person who has registered the authentic original document, who is stored in association with the registration data and based on user authentication information, namely, a user who has registered the authentic original document information. In addition, the user can specify a date of registration, namely, the date of registration of the authentic original document information.

The above-described items can be set as search conditions for searching for the registration information.

Each of the above-described conditions is used to identify registered authentic original document information (namely, the registration information). That is, the user can find the registered authentic original document information that matches an entered condition by inputting a condition as necessary, pressing an OK button 1311 to return to the screen illustrated in FIG. 12, and then pressing an OK button 1211.

In an embodiment, only one piece of registered authentic original document information that matches an entered condition can be extracted in the case where the user specifies the registration ID. Meanwhile, when the user specifies the registration date only, a plurality of pieces of registered authentic original document information that match an entered condition can be extracted. Furthermore, if no registered authentic original document information that matches an entered condition is found, a message indicating so can be displayed.

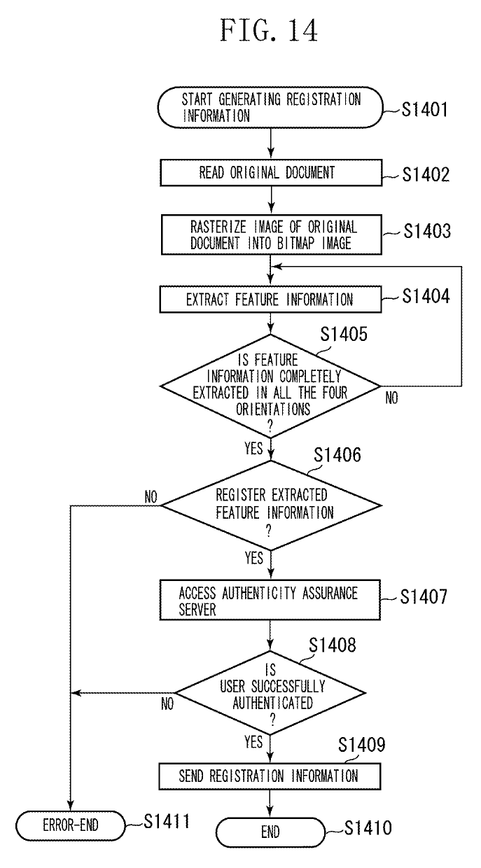

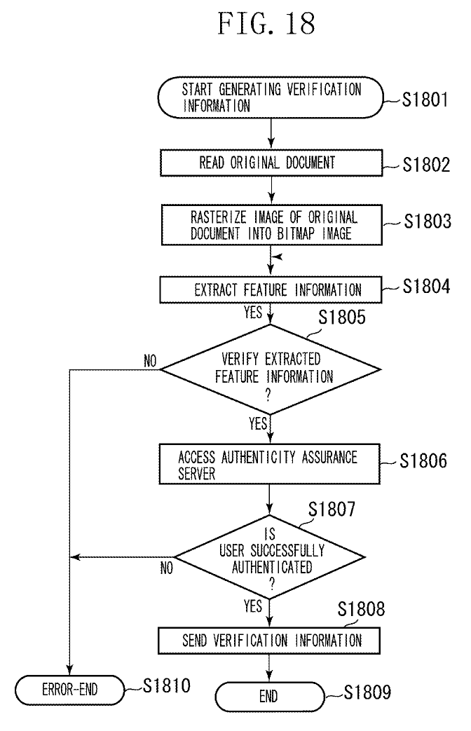

Each of flow charts illustrated in FIG. 14 and FIG. 18 illustrates an operation for reading a program stored in the program ROM 110 with the CPU 125 of the MFP 100 to control the MFP 100, which is performed in the processing for the “registration” and the “verification” illustrated in FIGS. 8 through 13.

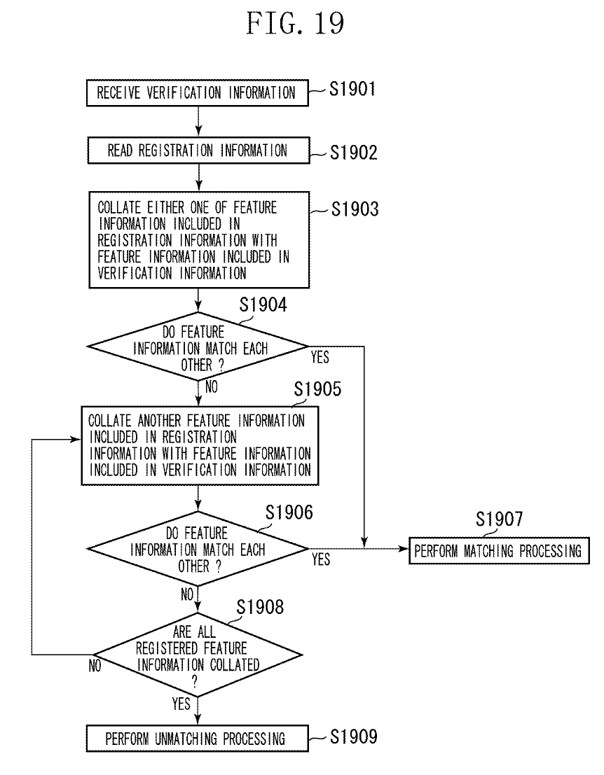

In addition, a flow chart illustrated in FIG. 19 illustrates an operation for reading a program stored in the program ROM 531 or the RAM 523 with the CPU 530 of the authenticity assurance server 403 to control the authenticity assurance server 403.

FIG. 14 is a flow chart illustrating an exemplary flow of processing performed for the “registration”.

Referring to FIG. 14, first, in step S1401, the CPU 125 starts generation of authentic original document information. The operation performed in step S1401 corresponds to the operation performed when the user presses the OK button 1011 illustrated in FIG. 10.

In step S1402, the CPU 125 reads an image of an original document that is to be registered as an authentic original document. In step S1403, the CPU 125 rasterizes image data acquired by the reading in step S1402 into a bitmap image. In step S1404, the CPU 125 extracts feature information from the bitmap image.

Here, with respect to the extraction of feature information in step S1404, a description is made as to a case where the radio button 1023 is selected via the screen illustrated in FIG. 10, namely, the case where the user specifies extracting feature information based on four different orientations.

Note that if necessary, a step for determining how many orientations are specified by the user for extracting feature information can be provided prior to step S1405.

In step S1404, the CPU 125 extracts feature information of the image with the feature information extraction unit 115 based on four orientations which differ by 90° between adjacent orientations. That is, assuming that feature information extracted based on one orientation is feature information at 0°, the CPU 125 further extracts feature information based on orientations in which the original document is rotated by 90°, 180°, and 270°, respectively.

Here, a description is made as to an effect of extracting feature information based on a plurality of different orientations.

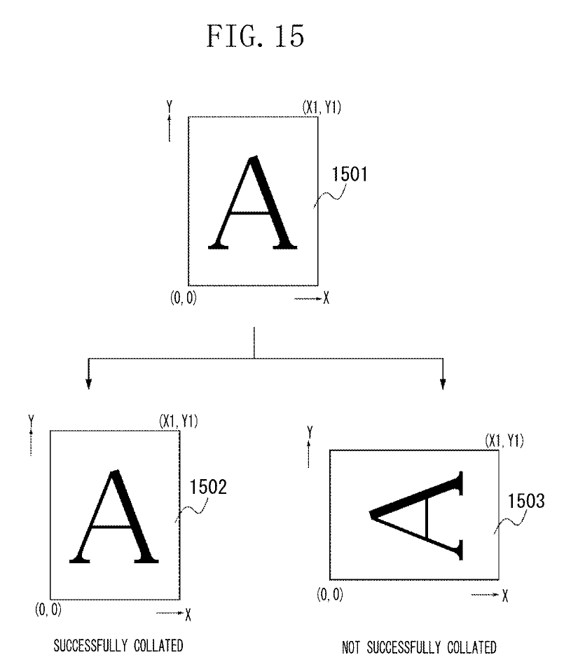

In a conventional method, first, as illustrated in FIG. 15, feature information is extracted from the area of an image 1501 to be registered. The area of the image 1501 illustrated in FIG. 15 covers a corner having coordinates (0, 0) and a corner having coordinates (X1, Y1), where the lower left corner of an image is determined to be an origin, and an X-axis is taken to the right of the origin and a Y-axis is taken to the left of the origin. More specifically, an algorithm whose computation result differs per each bit string is used to extract feature information from the image 1501 for each of bit strings having coordinates (0, 0), (1, 0) . . . (X1, 0), (0, 1) . . . (X1−1, Y1), and (X1, Y1). Then, the extracted feature information is registered with an authenticity assurance server.

Subsequently, an image to be verified for authenticity is read. In performing the verification for authenticity, as indicated by an image 1502, an original document is read, just as in the case of the image 1501. Then, the feature information of the area of the image 1502 covering an area from the corner having coordinates (0, 0) to the corner having coordinates (X1, Y1) is extracted, and the extracted feature information is sent to the authenticity assurance server.

The authenticity assurance server collates feature information that is previously registered with feature information sent for verification of authenticity. If it is determined by the authenticity assurance server that the feature information match each other, contents of the original documents are determined to be the same, that is, the original document to be examined for authenticity is determined not to have been altered (falsified).

However, in the above-described conventional method, because feature information is extracted without considering an orientation of an original document, the original document may be determined to have been altered even if the content of the original document is the same as the content of the authentic original document.

This problem occurs in the case where, for example, in reading an image to be verified, the image is read in an orientation different from an orientation in which the image 1501 is read, as indicated by an image 1503. That is, if feature information is extracted by reading an original document as indicated by the image 1503, bit strings in the area from the coordinates (0, 0) to the coordinates (X1, Y1) differ from those in the case of the image 1501. Accordingly, the feature information acquired by the extraction for verification differs from the feature information of the authentic original document.

In this case, although the image 1501 and the image 1503 have the same content, to which no falsification is applied, it is determined that the image 1503 has been altered, due to the difference between the feature information of the image 1501 and the image 1503.

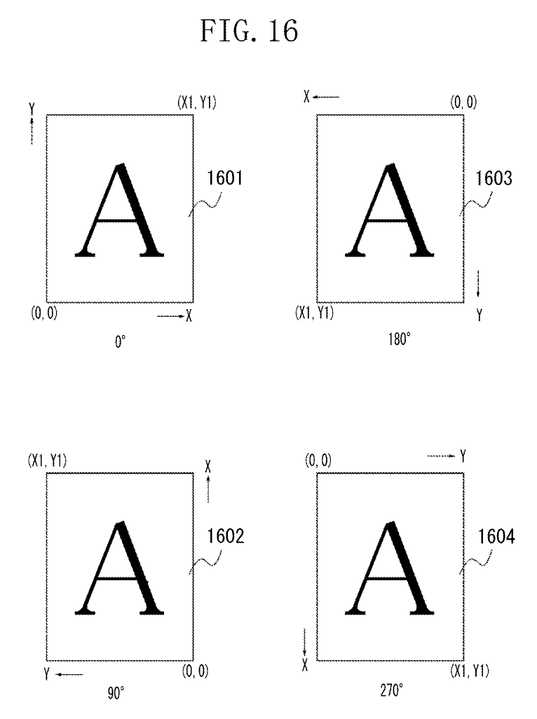

In this regard, according to the first exemplary embodiment, in order to solve such a problem, in extracting feature information of an image to be registered, four feature information are extracted based on four orientations which differ by 90° between adjacent orientations, as illustrated in FIG. 16.

For example, as indicated by an image 1601, if the orientation is determined to be at 0° in the case where a lower-left corner of the image 1601 in FIG. 16 is assumed to have coordinates (0, 0), then the orientation is determined to be at 90° when a lower-right corner of an image is assumed to have coordinates (0, 0) as indicated by an image 1602. The orientations at 180° (see an image 1603) and 270° (see an image 1604) are determined in a similar manner. Feature information is computed for each of the four orientations.

Note that at this time, in extracting feature information based on a plurality of different orientations, it is necessary to rotate the image data stored in the memory 180. The rotation is performed by the feature information extraction unit 115. However, a functional unit such as an image rotation unit, which is a unit different from the feature information extraction unit 115, can be separately provided in the program ROM 110.

Furthermore, with respect to the rotated image data, after feature information is extracted, original (unrotated) image data can be stored, and other image data can be deleted.

Thus, four different feature information are previously registered with the authenticity assurance server. Accordingly, regardless of the orientation in which an original document to be verified is set for reading, it can be properly determined that the verified original document has not been altered as long as the contents of the verified original document and the authentic original document are the same as each other. Thus, the user's convenience can be improved.

Note that in the present exemplary embodiment, four orientations, namely, 0°, 90°, 180°, and 270°, are used to extract feature information. However, the orientations used to extract feature information are not limited to the four orientations. That is, only two orientations at 0° and 180° can be used, or alternatively, feature information can be extracted based on any other suitable orientations.

Referring back to FIG. 14, after a plurality of feature information is extracted based on the four orientations in step S1404, the CPU 125 advances to step S1405. In step S1405, the CPU 125 determines whether the plurality of feature information is completely extracted based on all the four orientations.

If, in step S1405, it is determined that the plurality of feature information is completely extracted based on all the necessary orientations (YES in step S1405), then the CPU 125 advances to step S1406. On the other hand, if it is determined in step S1405 that an orientation in which the feature information is not extracted yet remains (NO in step S1405), then the CPU 125 returns to step S1404 to extract the remaining feature information.

In step S1406, the CPU 125 allows the user to finally confirm the content to be registered. More specifically, a preview of the read image can be displayed in the operation panel unit 140 or only the number of the pages from which feature information are extracted can be displayed in the operation panel unit 140.

If the user generates an instruction for registration in step S1406 (YES in step S406), then the CPU 125 advances to step S1407. In step S1407, the CPU 125, based on the information entered by the user, accesses the authenticity assurance server 403. Then, in step S1408, the CPU 125 performs a user authentication based on the authentication information entered by the user.

If the user is not successfully authenticated (NO in step S1408), then the CPU 125 advances to step S1411. In step S1407, the CPU 125 ends the processing while outputting an error message. If the user is successfully authenticated (YES in step S1408), then the CPU 125 advances to step S1409. In step S1409, the CPU 125 sends the registration information to the authenticity assurance server 403. In step S1410, the CPU 125 ends the processing.

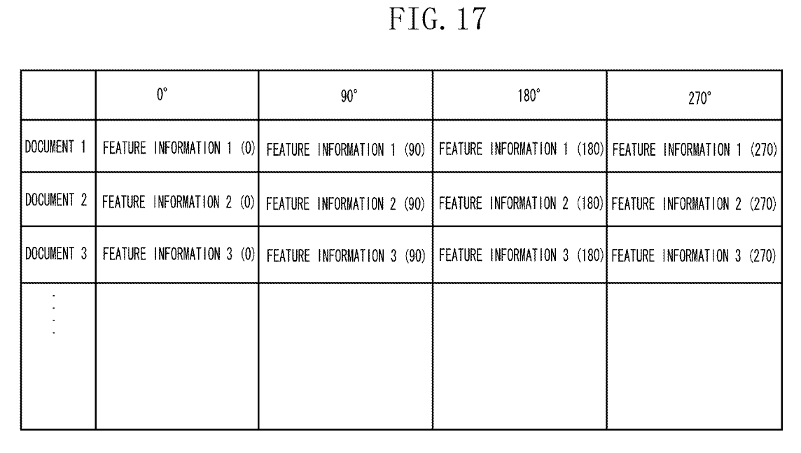

FIG. 17 illustrates an example of the feature information management table 570 in the authenticity assurance server 403, which has received the registration information (feature information) sent from the MFP 100 in step S1409.

With the feature information management table 570, the feature information extracted by the MFP 100 based on the four different orientations, which are associated with one another and are sent to the authenticity assurance server 403, can be managed in association with each registration information. Referring to FIG. 17, “feature information 1 (0)” corresponds to a “document 1” and indicates feature information extracted based on the orientation at 0° with respect to the “document 1”.

Note that when only the feature information extracted based on one specific orientation is sent from the MFP 100 to the authenticity assurance server 403, that is, when only one feature information is sent to the authenticity assurance server 403, the sent feature information can be input into the column corresponding to 0° and the other columns can be left empty.

FIG. 18 is a flow chart illustrating a flow of processing for the “verification” performed by the MFP 100.

Referring to FIG. 18, first, in step S1801, the CPU 125 of the MFP 100 starts generating verification information. The operation performed in step S1801 corresponds to the operation performed when the user presses the OK button 1311 illustrated in FIG. 13.

In step S1802, the CPU 125 reads an original document that is to be verified. In step S1803, the CPU 125 rasterizes the read image data into a bitmap image. In step S1804, the CPU 125 extracts feature information from the bitmap image.

Note that in the present exemplary embodiment, at the time of generating verification information, feature information is extracted based on one orientation only.

After feature information is extracted in step S1804, the CPU 125 advances to step S1805. In step S1805, the CPU 125 allows the user to finally confirm the verification content. More specifically, the CPU 125 displays the read images and the number of the pages from which feature information are extracted for user's confirmation. If no instruction for verification is generated by the user (NO in step S1805), the CPU 125 advances to step S1810. In step S1810, the CPU 125 ends the processing while outputting an error message.

If the user generates an instruction for verification (YES in step S1805), then the CPU 125 advances to step S1806. In step S1806, the CPU 125, based on the information entered by the user, accesses the authenticity assurance server 403. Then, in step S1807, the CPU 125 performs a user authentication based on the authentication information entered by the user.

If the user is not successfully authenticated (NO in step S1807), then in step S1810, the CPU 125 ends the processing while outputting an error message. If the user is successfully authenticated (YES in step S1807), then the CPU 125 advances to step S1808. In step S1808, the CPU 125 sends the verification information to the authenticity assurance server 403. In step S1809, the CPU 125 ends the processing.

FIG. 19 is a flow chart illustrating a flow of processing for the “verification” performed by the authenticity assurance server 403. Referring to FIG. 19, first, in step S1901, the CPU 125 receives the verification information and a registration ID for identifying registration information from the MFP 100 or the MFP 101.

In step S1902, the CPU 125 searches for registration information corresponding to the received registration ID. At this time, if a registration ID is already entered by the user via the screen illustrated in FIG. 13, the CPU 125 reads the registration information corresponding to the registration ID.

If no registration ID is specified, just as descried with reference to FIG. 13, the user can search for the corresponding registration information.

In step S1903, the CPU 125 collates the received verification information with the read registration information. At this time, if the registration information includes feature information extracted based on a plurality of orientations, such as 0°, 90°, 180°, and 270°, then the CPU 125 compares a first selected one of the feature information included in the registration information with the feature information included in the received verification information.

In step S1904, the CPU 125 determines whether the first selected one of the feature information included in the registration information matches the corresponding feature information included in the received verification information. If it is determined in step S1904 that the first selected one of the feature information included in the registration information does not match the corresponding feature information included in the received verification information ((NO in step S1904), then the CPU 125 advances to step S1905.

In step S1905, the CPU 125 compares feature information different from the first selected feature information that is subjected to the collation in step S1903, of the plural feature information included in the registration information, with the feature information included in the verification information.

In step S1906, the CPU 125 determines, as a result of the comparison in step S1905, whether the feature information different from the feature information that is subjected to the collation in step S1903 matches the feature information included in the verification information. If it is determined in step S1906 that the feature information different from the feature information that is subjected to the collation in step S1903 does not match the feature information included in the verification information (NO in step S1906), then the CPU 125 advances to step S1908.

If it is determined in step S1904 or in step S1906 that the feature information match each other (YES in step S1904 or S1906), then the CPU 125 advances to step S1907. In step S1907, the CPU 125 performs “matching processing”.

Here, the “matching processing” refers to processing in which as a result of comparison of the feature quantities that are included in the registration information and the verification information respectively, a notification indicating that the feature information match each other is sent to the MFP 100. The MFP 100 displays the content of the notification on the operation panel unit 140 or prints the content of the notification with the scanner apparatus 170.

Note that here, a certification certifying that the feature information match each other (that is, the contents of the original documents are the same as each other) can be issued.

In step S1908, the CPU 125 determines whether all the feature information included in the registration information are already collated with the feature information included in the verification information. If, of the feature information included in the registration information, feature information that is yet to be collated remains, the CPU 125 returns to step S1905 to collate the remaining feature information included in the registration information with the feature information included in the verification information.

If it is determined in step S1908 that all the feature information included in the registration information have already been collated with the feature information included in the verification information (YES in step S1908), then the CPU 125 advances to step S1909. In step S1909, the CPU 125 performs “unmatching processing”. The “unmatching processing” refers to processing in which as a result of collation of the feature information that are included in the registration information and the verification information respectively, a notification indicating that the feature information do not match each other is sent to the MFP 100.

Note that at this time, according to the notification indicating a “matching” or “unmatching” status from the authenticity assurance server 403, the MFP 100 can display the matching status on the liquid crystal panel unit 201 or print out the matching status. Thus, the result of the collation can be readily notified to the user.

According to the first exemplary embodiment described above, with an authenticity assurance system including an MFP that reads an original document and an authenticity assurance server that stores authentic original document information, authenticity assurance can be performed by comparing the registration information that is previously registered with the verification information about the original document to be verified.

Furthermore, in the first exemplary embodiment, in generating registration information, feature information are previously extracted based on four different orientations and the extracted feature information are registered in association with one another to be collated with feature information included in the verification information. Accordingly, an appropriate result of collation can be obtained even if original documents are read in mutually different orientations at the time of registration and verification.

### Second Exemplary Embodiment

Now, a second exemplary embodiment of the present invention is described. Note that units and portions similar to those in the first exemplary embodiment are provided with the same reference numerals and symbols, and accordingly, a description thereof is not repeated here. A point in difference between the first and second exemplary embodiments is that in the second exemplary embodiment, a plurality of feature information are not extracted at the time of generation of registration information but feature information are extracted based on four different orientations at the time of generation of verification information.

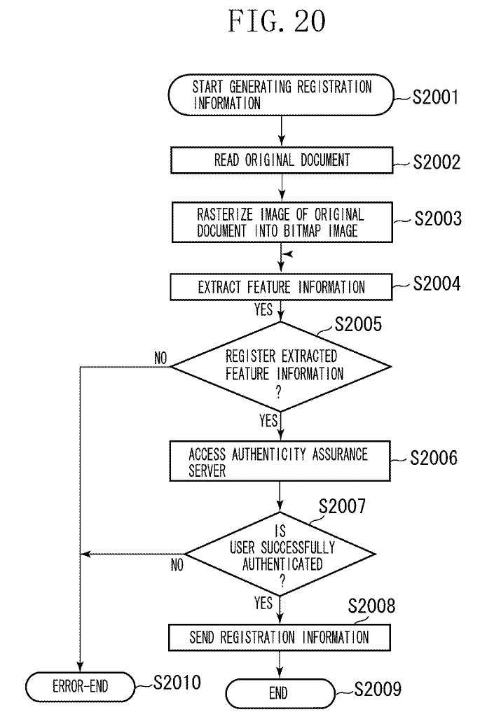

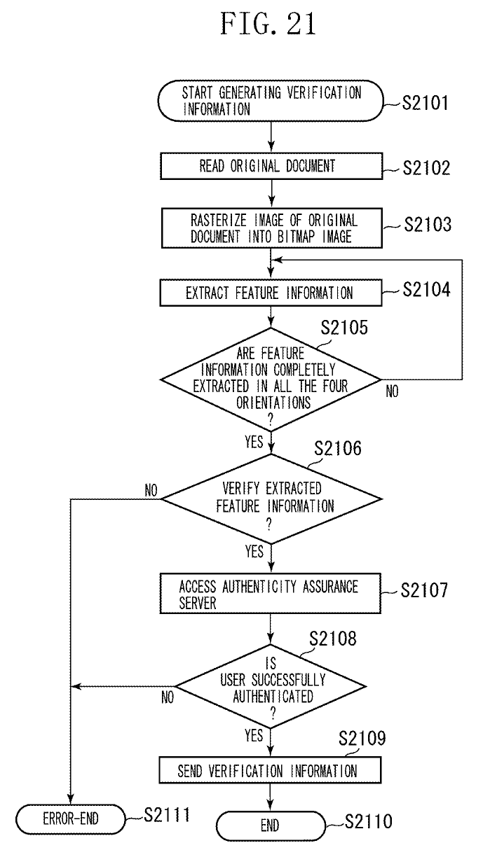

Each of flow charts illustrated in FIG. 20 and FIG. 21 illustrates an operation for reading a program stored in the program ROM 110 with the CPU 125 of the MFP 100 to control the MFP 100, which is performed in the “registration” processing and the “verification” processing according to the second exemplary embodiment

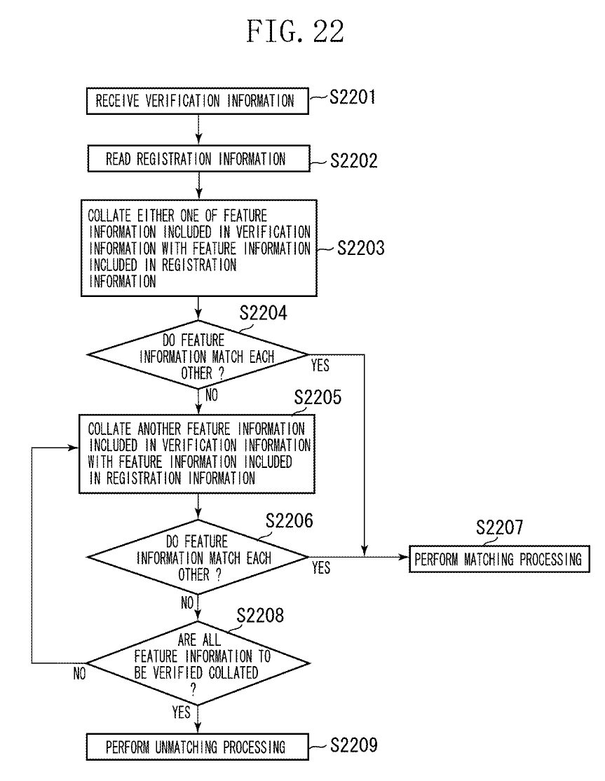

In addition, a flow chart illustrated in FIG. 22 illustrates an operation for reading a program stored in the program ROM 531 or the RAM 523 with the CPU 530 of the authenticity assurance server 403 to control the authenticity assurance server 403.

FIG. 20 is a flow chart illustrating an exemplary flow of processing performed for the “registration”.

Steps S2001 through S2003 and steps S2005 through S2010 are similar to steps S1401 through S1403 and steps S1405 through S1410 in the flow chart illustrated in FIG. 14. Accordingly, a description thereof is not repeated here. In step S2004, unlike the first exemplary embodiment, feature information is extracted based on one previously-set orientation, instead of feature information extracted based on a plurality of orientations.

FIG. 21 is a flow chart illustrating an exemplary flow of processing performed for the “verification”. Steps S2101 through S2103 and steps S2106 through S2111 are similar to steps S1801 through S1803 and steps S1805 through S1810 in the flow chart illustrated in FIG. 18. Accordingly, a description thereof is not repeated here.

In step S2104, unlike the first exemplary embodiment, feature information are extracted based on a plurality of different orientations, instead of feature information extracted based on one orientation.

In step S2105, the CPU 125 determines whether feature information are completely extracted based on all the four orientations. If it is determined in step S2105 that an orientation in which feature information is not extracted yet remains (NO in step S2105), then the CPU 125 returns to step S2104. On the other hand, if it is determined in step S2105 that feature information are completely extracted based on all the four orientations (YES in step S2105), the CPU 125 advances to step S2106.

FIG. 22 is a flow chart illustrating a flow of processing performed for the “verification” by the CPU 530 of the authenticity assurance server 403.

Referring to FIG. 22, first, in step S2201, the CPU 530 receives the verification information sent from the MFP 100 in step S2109. In step S2202, the CPU 530 reads the corresponding registration information.

At this time, if a registration ID is entered by the user via the screen illustrated in FIG. 13, then the CPU 530 reads registration information corresponding to the registration ID. If no registration ID is specified, as illustrated in the description with reference to FIG. 13, then the user can search for the corresponding registration information.

In step S2203, the CPU 530 collates the received verification data with the read registration data. At this time, if the verification information includes feature information extracted based on a plurality of orientations, such as 0°, 90°, 180°, and 270°, the CPU 530 compares either one of the feature information included in the verification information with the feature information included in the read registration information.

In step S2204, the CPU 530 determines whether feature information included in the verification information matches the corresponding feature information included in the read registration information. If it is determined in step S2204 that the feature information included in the verification information does not match the corresponding feature information included in the read registration information (NO in step S2204), then the CPU 530 advances to step S2205.

In step S2205, the CPU 530 compares feature information different from the feature information that is subjected to the collation in step S2203, of the feature information included in the verification information, with the feature information included in the registration information. In step S2206, the CPU 530 determines whether the feature information different from the feature information that is subjected to the collation in step S2203 matches the feature information included in the registration information. If it is determined in step S2206 that the feature information different from the feature information that is subjected to the collation in step S2203 does not match the feature information included in the registration information (NO in step S2206), then the CPU 530 advances to step S2208.

If it is determined in step S2204 or in step S2206 that the feature information match each other (YES in step S2204 or S2406), then the CPU 530 advances to step S2207. In step S2207, the CPU 530 performs “matching processing”.

Here, the “matching processing” refers to processing in which as a result of comparison of the feature information that are included in the registration information and the verification information, a notification indicating that the feature information match each other is sent to the MFP 100. Furthermore, a certification certifying that the feature information match each other can be issued.

If it is determined in step S2206 that the feature information different from the feature information that is subjected to the collation in step S2203 does not match the feature information included in the registration information (NO in step S2206), the CPU 530 advances to step S2208. In step S2208, the CPU 530 determines whether all the feature information included in the verification information are already collated with the corresponding feature information included in the read registration information. Here, if, of the feature information included in the verification information, feature information that is yet to be collated remains, the CPU 530 returns to step S2205 to collate the remaining feature information with the corresponding feature information included in the registration information.

If it is determined in step S2208 that all the feature information included in the verification information are already collated with the corresponding feature information included in the registration information (YES in step S2208), then the CPU 530 advances to step S2209. In step S2209, the CPU 530 performs “unmatching processing”. The “unmatching processing” refers to processing in which as a result of collation of the feature information that are included in the registration information and the verification information, a notification indicating that the feature information do not match each other is sent to the MFP 100.

Note that at this time, according to the notification indicating “matching” or “unmatching” from the authenticity assurance server 403, the MFP 100 can display the matching status on the liquid crystal panel unit 201 or print out the matching status. Thus, the result of the collation can be readily notified to the user.

According to the second exemplary embodiment described above, with an authenticity assurance system including an MFP that reads an original document and an authenticity assurance server that stores authentic original document information, authenticity assurance can be performed by comparing the registration information that is previously registered with the verification information about the original document to be verified.

Furthermore, in the second exemplary embodiment, in generating verification information, feature information are previously extracted based on four different orientations and each of the extracted feature information is sent to the authenticity assurance server 403 to allow the authenticity assurance server 403 to collate each feature information with the corresponding feature information included in the registration information. Accordingly, an appropriate result of collation can be obtained even if the orientations of original documents are different from each other at the time of registration and verification.

### Third Exemplary Embodiment

Now, a third exemplary embodiment of the present invention is described. Note that units and portions similar to those in the first and the second exemplary embodiments are provided with the same reference numerals and symbols, and accordingly, a description thereof is not repeated here. A point in difference in the third exemplary embodiment from the first and the second exemplary embodiments is that in the third exemplary embodiment, a plurality of feature information are not extracted at the time of generation of registration information and verification information but feature information are newly extracted based on different orientations when a notification indicating “unmatching” is received from the authenticity assurance server 403.

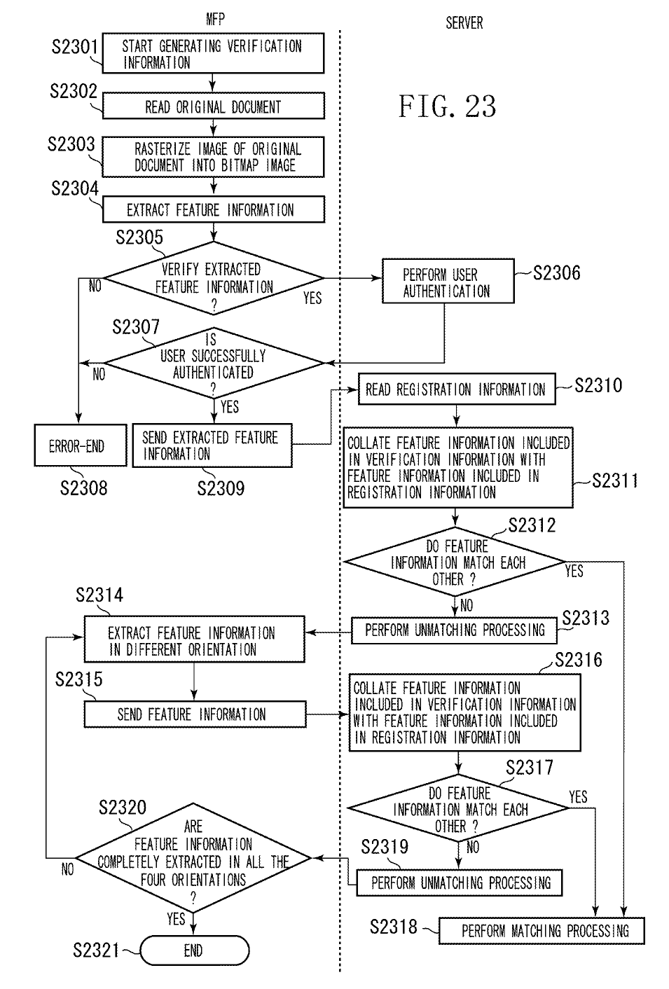

FIG. 23 is a flow chart illustrating a flow of processing performed by the CPU 125 of the MFP 100 and processing performed by the CPU 530 of the authenticity assurance server 403 in processing for the “verification” according to the third exemplary embodiment.

Note that the CPU 125 performs control by reading a program stored in the program ROM 110. The CPU 530 performs control by reading a program stored in the program ROM 531 or the RAM 523.

The operation performed in processing for the “registration” according to the third exemplary embodiment is similar to that in the second exemplary embodiment. Accordingly, a description thereof is not repeated here.

Referring to FIG. 23, in steps S2301 through S2304, the CPU 125 extracts feature information to be included in the verification information, just as in the first exemplary embodiment (see FIG. 18). In step S2305, the CPU 125 allows the user to finally confirm the verification content. More specifically, the CPU 125 displays previews of the read image and the number of the pages from which feature information are extracted for user's confirmation. If no instruction for verification is generated by the user (NO in step S2305), the CPU 125 advances to step S2308. In step S2308, the CPU 125 ends the processing while outputting an error message.

If the user generates an instruction for verification in step S2305 (YES in step S2305), then the CPU 125 accesses the authenticity assurance server 403. In step S2306, the CPU 530 of the authenticity assurance server 403 performs a user authentication and notifies a result of the authentication to the MFP 100.

In step S2307, the CPU 125 of the MFP 100, based on the result of the authentication notified from the authenticity assurance server 403, determines whether the user is not successfully authenticated. If the user is not successfully authenticated (NO in step S2307), then in step S2308, the CPU 125 ends the processing while outputting an error message. If the user is successfully authenticated (YES in step S2307), then the CPU 125 advances to step S2309.

In step S2309, the CPU 125 of the MFP 100 sends the feature information to the authenticity assurance server 403. Then, in step S2310, the CPU 530 of the authenticity assurance server 403 reads the registration information. In step S2311, the CPU 530 collates the feature information included in the read registration information with the feature information included in the received verification information.

In step S2312, the CPU 530 of the authenticity assurance server 403 determines, as a result of the collation in step S2311, whether the feature information included in the read registration information matches the feature information included in the received verification information. If it is determined in step S2312 that the feature information included in the read registration information matches the feature information included in the received verification information (YES in step S2312), the CPU 530 advances to step S2318. In step S2318, the CPU 530 performs “matching processing”. If, in step S2318, it is determined that the feature information included in the verification information and the feature information included in the registration information do not match each other (NO in step S2312), the CPU 530 advances to step S2313. In step S2313, the CPU 530 performs “unmatching processing”.

Here, in the “matching processing” and the “unmatching processing”, just as described in the first and the second exemplary embodiments, the CPU 530 of the authenticity assurance server 403 notifies a result of the collation to the MFP 100.

In the case where the CPU 530 performs the “unmatching processing” in step S2313, then in step S2314, the CPU 125 of the MFP 100, after receiving the result of the “unmatching processing”, newly extracts feature information based on an orientation different from the orientation used in extracting feature information in step S2304. At this time, because the feature information extraction unit 115 extracts feature information from the stored data obtained by reading the original document in step S2302, it is not necessary to newly read the original document.

In step S2315, the CPU 125 sends the feature information extracted in step S2314 to the authenticity assurance server 403. After the authenticity assurance server 403 receives the feature information from the MFP 100, in step S2316, the CPU 530 collates the feature information received from the MFP 100 with the feature information included in the registration information read in step S2310.

In step S2317, the CPU 530 of the authenticity assurance server 403 determines, as a result of the collation in step S2316, whether the feature information received from the MFP 100 matches the feature information included in the read registration information. If it is determined in step S2317 that the feature information received from the MFP 100 matches the feature information included in the read registration information (YES in step S2317), then the CPU 530 advances to step S2318 to perform the “matching processing”. If it is determined in step S2317 that the feature information received from the MFP 100 does not match the feature information included in the read registration information (NO in step S2317), then the CPU 530 advances to step S2319 to perform the “unmatching processing”.

In the case where the CPU 530 performs the “unmatching processing” in step S2319, then in step S2320, the CPU 125, after the MFP 100 receives the result of the “unmatching processing” from the authenticity assurance server 403, determines whether feature information are completely extracted in all the four orientations.

If it is determined in step S2320 that an orientation in which feature information is not extracted yet remains (NO in step S2320), then the CPU 125 returns to step S2314. In step S2314, the CPU 125 newly extracts feature information. Subsequently, the CPU 530 of the authenticity assurance server 403 performs the collation in the same manner as described above. On the other hand, if it is determined in step S2320 that feature information are completely extracted based on all the four orientations (YES in step S2320), the CPU 125 advances to step S2321 to end the processing.

In the first and the second exemplary embodiments, the MFP 100 displays a result of the collation on the liquid crystal panel unit 201 according to the notification of the “matching” status or the “unmatching” status from the authenticity assurance server 403. However, in the third exemplary embodiment, in the case where the “unmatching” status is notified from the authenticity assurance server 403 to the MFP 100, a result of the collation can be displayed according to the end of the processing in step S2321.

According to the third exemplary embodiment described above, with an authenticity assurance system including an MFP that reads an original document and an authenticity assurance server that stores authentic original document information, authenticity assurance can be performed by comparing the registration information that is previously registered with the verification information about the original document to be verified.

Furthermore, feature information extracted as the registration information and the verification information, are collated with each other, and if the feature information do not match each other, feature information is newly extracted based on an orientation different from the previously-used orientations. Accordingly, an appropriate result of collation can be obtained even if the orientations of original documents are different from each other at the time of registration and verification. Moreover, in the third exemplary embodiment, the number of times of extraction of the feature information is smaller than in the first and the second exemplary embodiment. Accordingly, a period of time required for extracting the feature information can be shortened.

Note that the present invention is not limited to the authenticity assurance server having the above-described configuration.

In the first through third exemplary embodiments, the authenticity assurance server 403 connected with the MFP 100 via a network is used as a unit that stores authentic original document information. However, the function provided by the authenticity assurance server 403 can be provided in the MFP 100 instead. Thus, even in the case where a sufficient network environment is not available, a simple authenticity assurance can be performed. In addition, in this case, it is not even necessary to send feature information via a network, which is more useful in terms of information security.

Furthermore, the present invention is not limited to a system that provides an authenticity assurance service, and can be applied to a service for storing electronic documents and to a function for registering a desired document in a document management server. That is, the present invention can be applied in simply searching for an image registered in a server apparatus or another MFP.

Moreover, the present invention is not limited to a method in which feature information extracted from data input by the scanner apparatus 170 is used. That is, feature information for registration or verification can be extracted from image data stored in a storage area such as a box to perform the registration processing and the verification processing.

### Other Exemplary Embodiments

Several exemplary embodiments of the present invention has been described above. However, the present invention can be implemented as a system, an apparatus, a method, a program, or a storage medium (recording medium). More specifically, the present invention can be applied to a system including a plurality of devices and to an apparatus that includes one device.

The present invention can be implemented by directly or remotely supplying a program of software implementing functions of the above-described exemplary embodiments (in the exemplary embodiments, the program corresponding to the processing performed according to the flow charts in the drawings) to a system or an apparatus and reading and executing supplied program code with the system or a computer of the apparatus.

Accordingly, the program code itself, which is installed on a computer for implementing the functional processing of the present invention with the computer, implements the present invention. That is, the present invention also includes a computer program for implementing the functional processing of the present invention.

Accordingly, the program can be configured in any form, such as object code, a program executed by an interpreter, and script data supplied to an operating system (OS).

As a recording medium for supplying such program code, a floppy disk, a hard disk, an optical disk, a magneto-optical disk (MO), a compact disc-read-only memory (CD-ROM), a compact disc-recordable (CD-R), a compact disc-rewritable (CD-RW), a magnetic tape, a nonvolatile memory card, a read-only memory (ROM), and a digital versatile disc (DVD) (a DVD-ROM and a DVD-R), for example, can be used.

The above program can also be supplied by connecting to a web site on the Internet by using a browser of a client computer and by downloading the program from the web site to a recording medium such as a hard disk. In addition, the above program can also be supplied by downloading a compressed file that includes an automatic installation function from the web site to a recording medium such as a hard disk. The functions of the above-described embodiments can also be implemented by dividing the program code into a plurality of files and downloading each divided file from different web sites. That is, a world wide web (WWW) server for allowing a plurality of users to download the program file for implementing the functional processing configures the present invention.

In addition, the above program can also be supplied by distributing a storage medium such as a CD-ROM and the like which stores the program according to the present invention after an encryption thereof; by allowing the user who is qualified for a prescribed condition to download key information for decoding the encryption from the web site via the Internet; and by executing and installing in the computer the encrypted program code by using the key information.

In addition, the functions according to the embodiments described above can be implemented not only by executing the program code read by the computer, but also implemented by the processing in which an OS or the like carries out a part of or the whole of the actual processing based on an instruction given by the program code.

Further, in another aspect of the embodiment of the present invention, after the program code read from the recording medium is written in a memory provided in a function expansion board inserted in a computer or a function expansion unit connected to the computer, a CPU provided in the function expansion board or the function expansion unit carries out a part of or the whole of the processing to implement the functions of the embodiments described above.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-102088 filed Apr. 3, 2006, which is hereby incorporated by reference herein in its entirety.

What is claimed is:

1. An apparatus comprising:
an extraction unit configured to, based on an image of a document, extract feature information of the image;
a storage unit configured to store first document information including a plurality of feature information, which are extracted by the extraction unit from an image of a first document and respectively extracted based on a plurality of different orientations, and second document information including feature information, which is extracted by the extraction unit from an image of a second document and extracted based on at least one orientation;
a comparison unit configured to compare the feature information included in the second document information with the plurality of feature information included in the first document information;
a determination unit configured to determine, as a result of a comparison by the comparison unit, if either one of the plurality of feature information included in the first document information matches the feature information included in the second document information, that the first document and the second document are the same, and if none of the plurality of feature information included in the first document information matches the feature information included in the second document information, that the first document and the second document are not the same; and
an output unit configured to output information indicating a result of a determination by the determination unit.

2. The apparatus according to claim 1, further comprising a reading unit configured to read and input an image of a document,
wherein the extraction unit extracts the feature information of the image based on the image of the document read by the reading unit.

3. The apparatus according to claim 1, wherein the extraction unit, in extracting the plurality of feature information from the image of the first document, extracts the feature information based on each of four orientations which differ by 90 degrees between adjacent orientations.

4. The apparatus according to claim 1, wherein the storage unit previously stores the first document information, and
wherein the comparison unit, using the first document information previously stored in the storage unit and the second document information stored later in the storage unit for comparison with the first document information, compares the feature information included in the first document information with the feature information included in the second document information.

5. The apparatus according to claim 1, wherein the output unit comprises one of a display apparatus configured to display a result of a determination by the determination unit or a printing apparatus configured to print a result of a determination by the determination unit.

6. A system comprising:
an extraction unit configured to, based on an image of a document, extract feature information of the image;
a storage unit configured to store first document information including a plurality of feature information, which are extracted by the extraction unit from an image of a first document and respectively extracted based on a plurality of different orientations, and second document information including feature information, which is extracted by the extraction unit from an image of a second document and extracted based on at least one orientation;
a comparison unit configured to compare the feature information included in the second document information with the plurality of feature quantities included in the first document information;
a determination unit configured to determine, as a result of a comparison by the comparison unit, if either one of the plurality of feature information included in the first document information matches the feature information included in the second document information, that the first document and the second document are the same, and if none of the plurality of feature information included in the first document information matches the feature information included in the second document information, that the first document and the second document are not the same; and
an output unit configured to output information indicating a result of a determination by the determination unit.

7. The system according to claim 6, further comprising an information processing apparatus and a server apparatus that are configured to be in communication with each other via a network,
wherein the information processing apparatus comprises a sending unit configured to send the first document information and the second document information to the server apparatus via the network;
wherein the server apparatus comprises a receiving unit configured to receive the first document information and the second document information from the information processing apparatus; and
wherein the storage unit stores the first document information and the second document information that received by the receiving unit.

8. The system according to claim 7, wherein the server apparatus includes an authenticity assurance server apparatus configured to assure that the second document is authentic if the determination unit determines that the first document and the second document are the same.

9. A method comprising:
storing first document information including a plurality of feature information, which are extracted from an image of a first document and respectively extracted based on a plurality of different orientations;
storing second document information including feature information, which is extracted from an image of a second document and extracted based on at least one orientation;
comparing the feature information included in the second document information with the plurality of feature information included in the first document information; and
determining, as a result of the comparison, if either one of the plurality of feature information included in the first document information matches the feature information included in the second document information, that the first document and the second document are the same.

10. The method according to claim 9, further comprising:
determining, as a result of the comparison, if none of the plurality of feature information included in the first document information matches the feature information included in the second document information, that the first document and the second document are not the same.

11. The method according to claim 10, further comprising:
outputting information indicating a result of the determination.

12. A computer-readable storage medium storing instructions which, when executed by an apparatus, causes the apparatus to perform operations comprising:
storing first document information including a plurality of feature information, which are extracted from an image of a first document and respectively extracted based on a plurality of different orientations;
storing second document information including feature information, which is extracted from an image of a second document and extracted based on at least one orientation;
comparing the feature information included in the second document information with the plurality of feature information included in the first document information; and
determining, as a result of the comparison, if either one of the plurality of feature information included in the first document information matches the feature information included in the second document information, that the first document and the second document are the same.

13. The computer-readable storage medium according to claim 12, wherein the operations further comprise:
determining, as a result of the comparison, if none of the plurality of feature information included in the first document information matches the feature information included in the second document information, that the first document and the second document are not the same.

14. The computer-readable storage medium according to claim 13, wherein the operations further comprise:
outputting information indicating a result of the determination.

15. An apparatus comprising:
a storage unit to store first document information including first feature information extracted from an image of a first document based on a first orientation, the first document information further including second feature information extracted from the image of the first document based on a second orientation, the storage unit to store second original document information including feature information which is extracted from an image of a second document based on at least one orientation; and
a determination unit configured to determine if the feature information included in the second document information matches with either the first feature information or the second feature information included in the first document information.

16. The apparatus according to claim 15, wherein the first orientation and the second orientation differ by 180 degrees.

17. The apparatus according to claim 15, wherein the first document information stored in the storage unit further includes third feature information extracted from the image of the first document based on a third orientation and fourth feature information extracted from the image of the first document based on a fourth orientation,
wherein the first orientation, the second orientation, the third orientation and the fourth orientation differ by 90 degrees between adjacent orientations.

18. The apparatus according to claim 17, wherein the determination unit determines if the feature information included in the second document information matches with any one of the first feature information, the second feature information, the third feature information and the fourth feature information included in the first document information.
